(19) United States
(12) Patent Application Publication
(10) Pub. No.: US 2018/0123992 A1
(43) Pub. Date: May 3, 2018

(54) VISIBILITY FILTER FOR MESSAGE CONTENT

(71) Applicant: Microsoft Technology Licensing, LLC, Redmond, WA (US)

(72) Inventors: Chao Yu, Sammamish, WA (US); Selvi S. Chennai, Sammamish, WA (US)

(21) Appl. No.: 15/388,905

(22) Filed: Dec. 22, 2016

Related U.S. Application Data
(60) Provisional application No. 62/416,006, filed on Nov. 1, 2016.

(51) Int. Cl. H04L 12/58; H04L 29/08

(52) U.S. Cl. CPC H04L 51/12; H04L 67/306; H04L 67/10

(57) ABSTRACT

Non-limiting examples of the present disclosure describe a visibility filter that is applicable to filter content provides through an application/service. A visibility filter may be utilized to filter message content provided through a media call application. A query may be received through an executing instance of the media call application. In one example, an executing instance is an active communication session of the media call application. Message content may be accessed based on the received query, for instance, by a visibility service associated with the media call application. The message content may be filtered based on an application of visibility rules that are utilized to evaluate whether a user of the media call application is authorized to access the message content. Filtered message content may be transmitted for display within the media call application. Other examples are also provided including examples of client side processing.

### CROSS-REFERENCE TO RELATED APPLICATION(S)

This application is a Non-Provisional Patent Application of, and claims priority to, U.S. Provisional Patent Application No. 62/416,006, filed Nov. 1, 2016, entitled “VISIBILITY FILTER FOR MESSAGE CONTENT” which is incorporated herein by reference in its entirety.

### BACKGROUND

Applications/services have made it easier to gain access to content. As an example, communication applications may provide searchable access to message content including prior communications made through a communication application. A user may be conducting a chat session (e.g. through a communication application) and want to access message content while in the chat session. However, unfettered access to message content can lead to unauthorized access to message content. Existing technical solutions attempt to manage visibility of messages by providing a separate mailbox like container for each consumer. In most instances, visibility is limited to only the user mailbox. This type of solution is costly as it replicates the shared content to individual mailboxes. Furthermore, security measures typically implemented in existing solutions provide a single layer of authentication through a security schema that authenticates a user's identity. For instance, when a user logs in to an application/service and is authenticated, the user has full access to all message content. As such, examples of the present application are directed to the general technical environment related to contextual management of authorization to content, among other examples.

### SUMMARY

Non-limiting examples of the present disclosure describe a visibility filter that is applicable to filter content provides through an application/service. In one example, a visibility filter may be utilized to filter message content provided through a media call application. A query may be received through an executing instance of the media call application. In one example, an executing instance is an active communication session of the media call application. Message content may be accessed based on the received query. For instance, a visibility service associated with the media call application may access and filter the message content. The message content may be filtered based on an application of visibility rules that are utilized to evaluate whether a user of the media call application is authorized to access the message content. Examples of visibility rules used for evaluation are provided herein. Filtered message content may be transmitted for display within the media call application. Other examples are also provided including examples of client side processing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a block diagram illustrating an example of a computing device with which aspects of the present disclosure may be practiced.

FIGS. 2A and 2B are simplified block diagrams of a mobile computing device with which aspects of the present disclosure may be practiced.

FIG. 3 is a simplified block diagram of a distributed computing system in which aspects of the present disclosure may be practiced.

FIG. 4A is a process flow diagramming an interaction with an exemplary visibility service with which aspects of the present disclosure may be practiced.

FIG. 4B is a process flow diagramming components of an exemplary visibility service with which aspects of the present disclosure may be practiced.

FIG. 5 is an exemplary method related to processing of an exemplary visibility service with which aspects of the present disclosure may be practiced.

FIG. 6 is an exemplary method related to client side processing for execution of an exemplary media call application with which aspects of the present disclosure may be practiced.

### DETAILED DESCRIPTION

Non-limiting examples of the present disclosure provide an exemplary visibility service that can be interfaced with applications/services to enable contextual evaluation of users and/or content to appropriately filter content for viewing within an application/service. Previous solutions tie visibility of message content purely to user authentication rather than treating visibility as a function of a communication session occurring between users. In examples, a visibility index is implemented as a value-added service that is layered within an exemplary media call application/service to enable secure filtering of message content that ensure authorized access to message content. In one example filtered message content may be provided during communication sessions occurring in the media call application/service. However, an exemplary media call application may be configured to provide filtered message content in any executing instance including outside of a communication session. For ease of understanding, examples described herein describe a media call application/service. However, an exemplary visibility service implementing a visibility index can be utilized by any type of application/service.

Accordingly, the present disclosure provides a plurality of technical advantages including but not limited to: implementation of an exemplary visibility service providing multiple layers of security that prevent unauthorized access to data, ability to automate processing for filtering content including more efficient operation of processing devices (e.g., saving computing cycles/computing resources) when implementing an exemplary visibility service, improved user action with an exemplary media call application/service and extensibility to integrate processing operations described herein in a variety of different applications/services, among other examples.

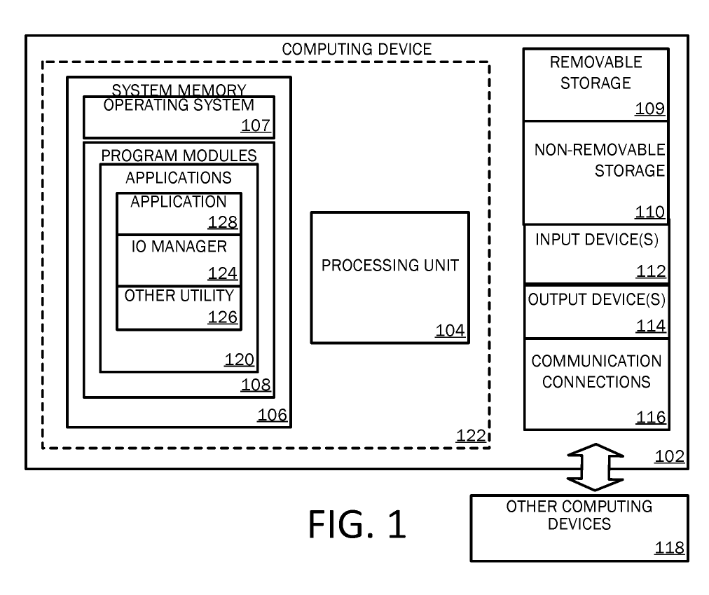

FIGS. 1-3 and the associated descriptions provide a discussion of a variety of operating environments in which examples of the invention may be practiced. However, the devices and systems illustrated and discussed with respect to FIGS. 1-3 are for purposes of example and illustration and are not limiting of a vast number of computing device configurations that may be utilized for practicing examples of the invention, described herein.

FIG. 1 is a block diagram illustrating physical components of a computing device 102, for example a mobile processing device, with which examples of the present disclosure may be practiced. Among other examples, computing device 102 may be an exemplary computing device configured for execution of an exemplary media call application/service and/or an exemplary visibility service as described herein. In a basic configuration, the computing device 102 may include at least one processing unit 104 and a system memory 106. Depending on the configuration and type of computing device, the system memory 106 may comprise, but is not limited to, volatile storage (e.g., random access memory), non-volatile storage (e.g., read-only memory), flash memory, or any combination of such memories. The system memory 106 may include an operating system 107 and one or more program modules 108 suitable for running software programs/modules 120 such as IO manager 124, other utility 126 and application 128. As examples, system memory 106 may store instructions for execution. Other examples of system memory 106 may store data associated with applications. The operating system 107, for example, may be suitable for controlling the operation of the computing device 102. Furthermore, examples of the invention may be practiced in conjunction with a graphics library, other operating systems, or any other application program and is not limited to any particular application or system. This basic configuration is illustrated in FIG. 1 by those components within a dashed line 122. The computing device 102 may have additional features or functionality. For example, the computing device 102 may also include additional data storage devices (removable and/or non-removable) such as, for example, magnetic disks, optical disks, or tape. Such additional storage is illustrated in FIG. 1 by a removable storage device 109 and a non-removable storage device 110.

As stated above, a number of program modules and data files may be stored in the system memory 106. While executing on the processing unit 104, program modules 108 (e.g., Input/Output (I/O) manager 124, other utility 126 and application 128) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 102 may also have one or more input device(s) 112 such as a keyboard, a mouse, a pen, a sound input device, a device for voice input/recognition, a touch input device, etc. The output device(s) 114 such as a display, speakers, a printer, etc. may also be included. The aforementioned devices are examples and others may be used. The computing device 104 may include one or more communication connections 116 allowing communications with other computing devices 118. Examples of suitable communication connections 116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 106, the removable storage device 109, and the non-removable storage device 110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

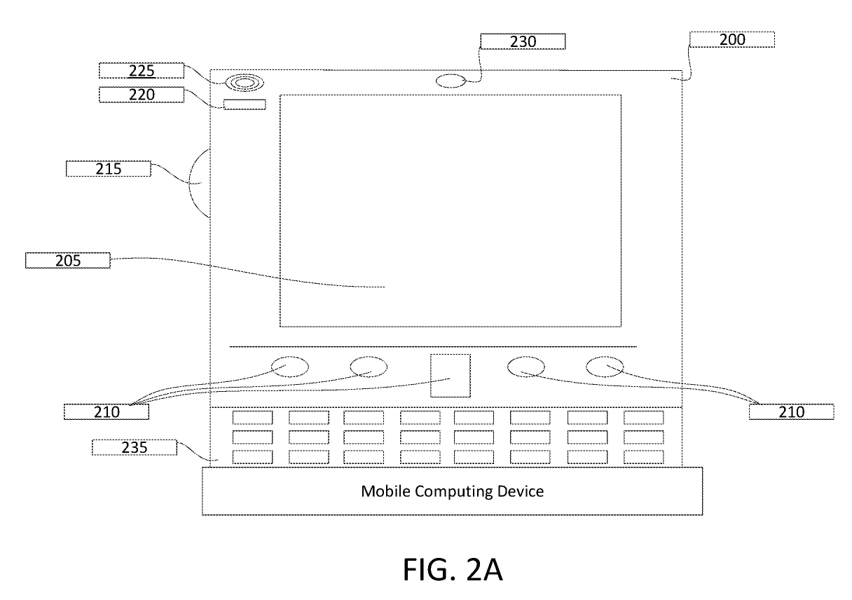

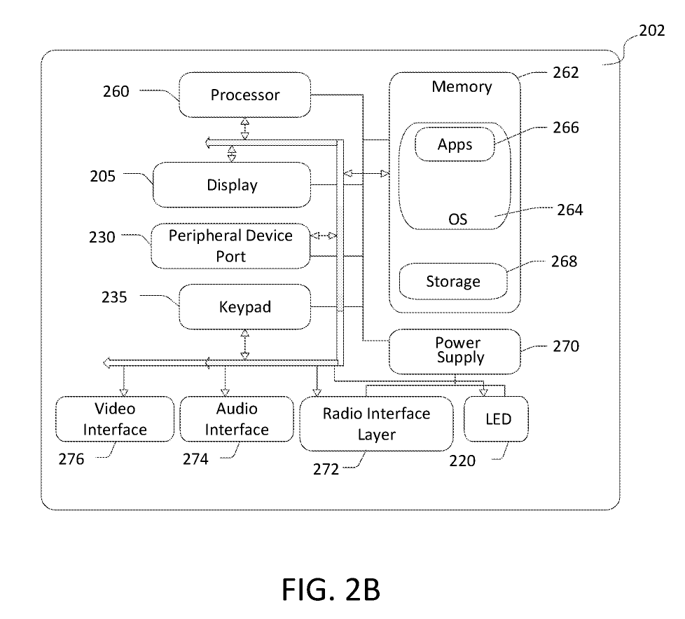

FIGS. 2A and 2B illustrate a mobile computing device 200, for example, a mobile telephone, a smart phone, a personal data assistant, a tablet personal computer, a phablet, a slate, a laptop computer, and the like, with which examples of the invention may be practiced. Mobile computing device 200 may be an exemplary computing device configured for execution of an exemplary media call application/service and/or an exemplary visibility service as described herein. Application command control may be provided for applications executing on a computing device such as mobile computing device 200. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 2A, one example of a mobile computing device 200 for implementing the examples is illustrated. In a basic configuration, the mobile computing device 200 is a handheld computer having both input elements and output elements. The mobile computing device 200 typically includes a display 205 and one or more input buttons 210 that allow the user to enter information into the mobile computing device 200. The display 205 of the mobile computing device 200 may also function as an input device (e.g., touch screen display). If included, an optional side input element 215 allows further user input. The side input element 215 may be a rotary switch, a button, or any other type of manual input element. In alternative examples, mobile computing device 200 may incorporate more or less input elements. For example, the display 205 may not be a touch screen in some examples. In yet another alternative example, the mobile computing device 200 is a portable phone system, such as a cellular phone. The mobile computing device 200 may also include an optional keypad 235. Optional keypad 235 may be a physical keypad or a “soft” keypad generated on the touch screen display or any other soft input panel (SIP). In various examples, the output elements include the display 205 for showing a GUI, a visual indicator 220 (e.g., a light emitting diode), and/or an audio transducer 225 (e.g., a speaker). In some examples, the mobile computing device 200 incorporates a vibration transducer for providing the user with tactile feedback. In yet another example, the mobile computing device 200 incorporates input and/or output ports, such as an audio input (e.g., a microphone jack), an audio output (e.g., a headphone jack), and a video output (e.g., a HDMI port) for sending signals to or receiving signals from an external device.

FIG. 2B is a block diagram illustrating the architecture of one example of a mobile computing device. That is, the mobile computing device 200 can incorporate a system (i.e., an architecture) 202 to implement some examples. In one examples, the system 202 is implemented as a “smart phone” capable of running one or more applications (e.g., browser, e-mail, calendaring, contact managers, messaging clients, games, and media clients/players). In some examples, the system 202 is integrated as a computing device, such as an integrated personal digital assistant (PDA), tablet and wireless phone.

One or more application programs 266 may be loaded into the memory 262 and run on or in association with the operating system 264. Examples of the application programs include phone dialer programs, e-mail programs, personal information management (PIM) programs, word processing programs, spreadsheet programs, Internet browser programs, messaging programs, and so forth. The system 202 also includes a non-volatile storage area 268 within the memory 262. The non-volatile storage area 268 may be used to store persistent information that should not be lost if the system 202 is powered down. The application programs 266 may use and store information in the non-volatile storage area 268, such as e-mail or other messages used by an e-mail application, and the like. A synchronization application (not shown) also resides on the system 202 and is programmed to interact with a corresponding synchronization application resident on a host computer to keep the information stored in the non-volatile storage area 268 synchronized with corresponding information stored at the host computer. As should be appreciated, other applications may be loaded into the memory 262 and run on the mobile computing device (e.g. system 202) described herein.

The system 202 has a power supply 270, which may be implemented as one or more batteries. The power supply 270 might further include an external power source, such as an AC adapter or a powered docking cradle that supplements or recharges the batteries.

The system 202 may include peripheral device port 230 that performs the function of facilitating connectivity between system 202 and one or more peripheral devices. Transmissions to and from the peripheral device port 230 are conducted under control of the operating system (OS) 264. In other words, communications received by the peripheral device port 230 may be disseminated to the application programs 266 via the operating system 264, and vice versa.

The system 202 may also include a radio interface layer 272 that performs the function of transmitting and receiving radio frequency communications. The radio interface layer 272 facilitates wireless connectivity between the system 202 and the “outside world,” via a communications carrier or service provider. Transmissions to and from the radio interface layer 272 are conducted under control of the operating system 264. In other words, communications received by the radio interface layer 272 may be disseminated to the application programs 266 via the operating system 264, and vice versa.

The visual indicator 220 may be used to provide visual notifications, and/or an audio interface 274 may be used for producing audible notifications via the audio transducer 225 (as described in the description of mobile computing device 200). In the illustrated example, the visual indicator 220 is a light emitting diode (LED) and the audio transducer 225 is a speaker. These devices may be directly coupled to the power supply 270 so that when activated, they remain on for a duration dictated by the notification mechanism even though the processor 260 and other components might shut down for conserving battery power. The LED may be programmed to remain on indefinitely until the user takes action to indicate the powered-on status of the device. The audio interface 274 is used to provide audible signals to and receive audible signals from the user. For example, in addition to being coupled to the audio transducer 225 (shown in FIG. 2A), the audio interface 274 may also be coupled to a microphone to receive audible input, such as to facilitate a telephone conversation. In accordance with examples of the present invention, the microphone may also serve as an audio sensor to facilitate control of notifications, as will be described below. The system 202 may further include a video interface 276 that enables an operation of an on-board camera 230 to record still images, video stream, and the like.

A mobile computing device 200 implementing the system 202 may have additional features or functionality. For example, the mobile computing device 200 may also include additional data storage devices (removable and/or non-removable) such as, magnetic disks, optical disks, or tape. Such additional storage is illustrated in FIG. 2B by the non-volatile storage area 268.

Data/information generated or captured by the mobile computing device 200 and stored via the system 202 may be stored locally on the mobile computing device 200, as described above, or the data may be stored on any number of storage media that may be accessed by the device via the radio 272 or via a wired connection between the mobile computing device 200 and a separate computing device associated with the mobile computing device 200, for example, a server computer in a distributed computing network, such as the Internet. As should be appreciated such data/information may be accessed via the mobile computing device 200 via the radio 272 or via a distributed computing network. Similarly, such data/information may be readily transferred between computing devices for storage and use according to well-known data/information transfer and storage means, including electronic mail and collaborative data/information sharing systems.

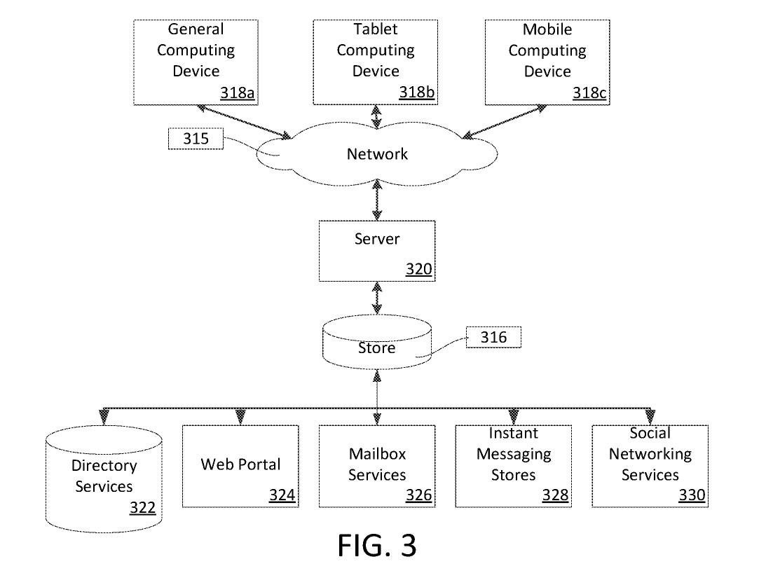

FIG. 3 illustrates one example of the architecture of a system for providing an application that reliably accesses target data on a storage system and handles communication failures to one or more client devices, as described above. The system of FIG. 3 may be an exemplary system configured for execution of an exemplary media call application/service and/or an exemplary visibility service as described herein. Target data accessed, interacted with, or edited in association with programming modules 108 and/or applications 120 and storage/memory (described in FIG. 1) may be stored in different communication channels or other storage types. For example, various documents may be stored using a directory service 322, a web portal 324, a mailbox service 326, an instant messaging store 328, or a social networking site 330, application 128, IO manager 124, other utility 126, and storage systems may use any of these types of systems or the like for enabling data utilization, as described herein. A server 320 may provide storage system for use by a client operating on general computing device 102 and mobile device(s) 200 through network 315. By way of example, network 315 may comprise the Internet or any other type of local or wide area network, and a client node may be implemented for connecting to network 315. Examples of a client node comprise but are not limited to: a computing device 102 embodied in a personal computer, a tablet computing device, and/or by a mobile computing device 200 (e.g., mobile processing device). As an example, a client node may connect to the network 315 using a wireless network connection (e.g. WiFi connection, Bluetooth, etc.). However, examples described herein may also extend to connecting to network 315 via a hardwire connection. Any of these examples of the client computing device 102 or 200 may obtain content from the store 316.

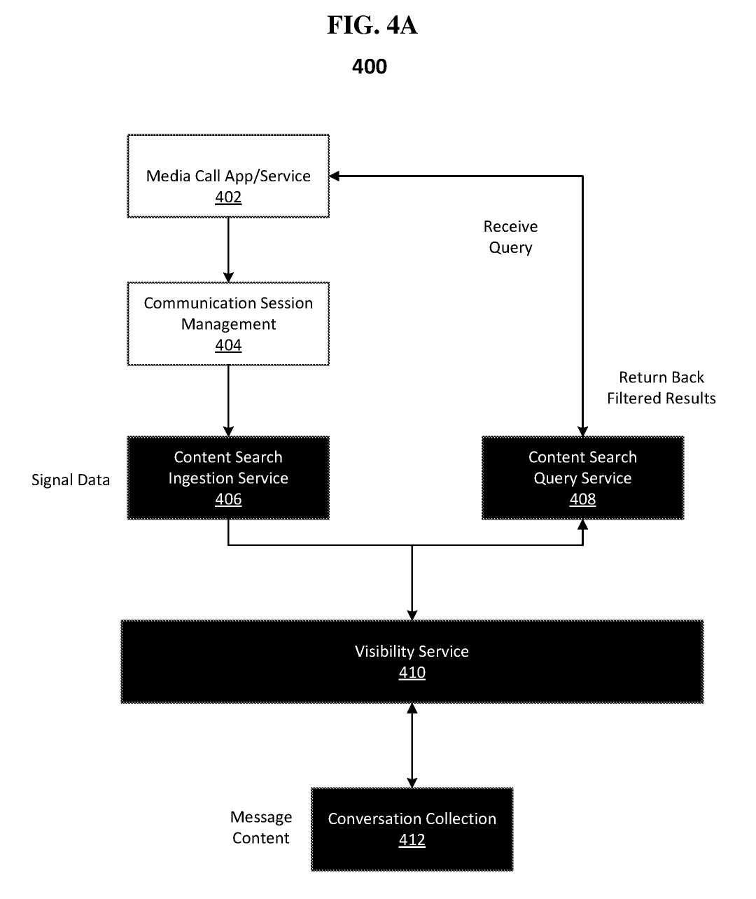

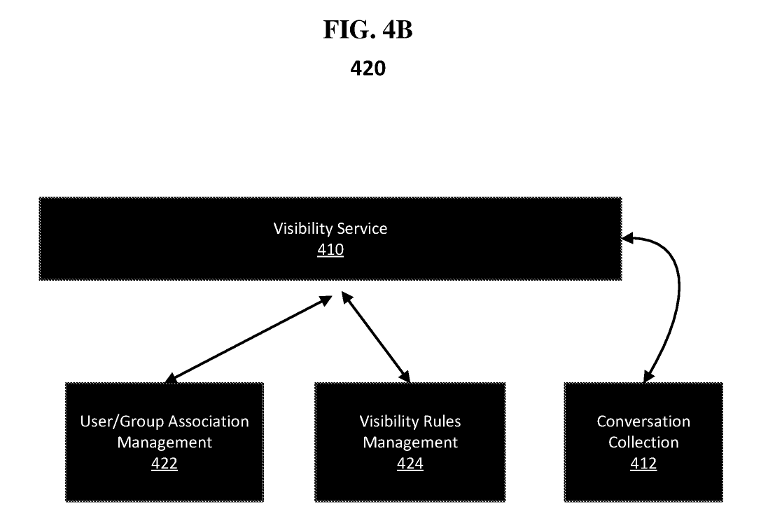

FIG. 4A is a process flow 400 diagramming an interaction with an exemplary visibility service with which aspects of the present disclosure may be practiced. As an example, process flow 400 illustrates an interaction between a client computing device, executing a media call application, and services supporting the media call application. An exemplary media call application is configured to provide services to enable call/media communication between a computing device and one or more other computing devices and/or telephones. In one example the media call application is configured to deliver communications (e.g. in a communication session) over an IP network such as the Internet, for example, via a voice over internet protocol (VoIP) communication. In another example, the media call application is configured to enable a communication session over a public switched telephone network (PSTN), for example, through an application. In further examples, an exemplary media call application may be involved in a communication session that includes both VoIP and PSTN devices. Examples of exemplary media call applications include but are not limited to: Skype®, Skype For Business®, SkypeOut® and SkypeIn®, among other examples. An exemplary media call application may comprise components configured to encode and/or decode data streams.

Furthermore, an exemplary media call application may interface with other application services. Application services may be any resource that may extend functionality of one or more components of the media call application and/or associated services such as an exemplary visibility service. Application services may include but are not limited to: personal intelligent assistant services, productivity applications, web search services, e-mail applications, calendars, device management services, address book services, informational services, line-of-business (LOB) management services, customer relationship management (CRM) services, debugging services, accounting services, payroll services and services and/or websites that are hosted or controlled by third parties, among other examples. Application services may further include other websites and/or applications hosted by third parties such as social media websites; photo sharing websites; video and music streaming websites; search engine websites; sports, news or entertainment websites, and the like. Application services may further provide analytics, data compilation and/or storage service, etc.

Examples described herein relate to an exemplary visibility service that provides filtering for message content that may be accessed through an exemplary media call application. Filtering provided by an exemplary visibility service enables safe, functional searching of message content, for example, preventing unauthorized display or access to message content. For ease of understanding, examples described herein describe application of a visibility service to an exemplary media call application/service. However, an exemplary visibility service can be incorporated into any type of application/service and can be configured to be implemented on top of any type data store(s). As an example, the visibility service can be implemented as an add-on (or be accessed by) to an existing service to provide an added layer of authorization for protecting access to any type of content (e.g. message content).

Exemplary message content may comprise a history of messages from previous communication sessions, conversations, messages, etc. within an exemplary media call application/service. However, message content is not limited to just content of a media call application. Message content may be content retrieved from data stores associated with any type of application/service. As an example, a media call application/service may be a component of a platform that provides a plurality of different applications/services. In one example, message content may be associated with data stores corresponding with different application/services of an exemplary platform. In other examples, message content may be retrieved from third-party resources that may interface with an exemplary media call application/service.

An exemplary data store (or data stores) may manage storage of message content. In one example, message content may be user specific data (e.g. conversations, content from past communication sessions associated with one or more users, videos, emails, text messages, etc.) that occur within a media call service. A data store may have one or more data storages associated therewith. Storages may be configured to connect with a media call application/service over a distributed network, for example, that provides cloud computing platforms and infrastructure services. Exemplary storages may be any of a first-party source, a second-party source, and a third-party source. Storages are any physical or virtual memory space. Additionally, storages may store any data for processing operations performed by a media call application or other associated services such as an exemplary visibility service.

For ease of understanding FIG. 4A, components of process flow 400 that are identified by white boxes relate to front-end processing components, which are viewable by a client component device. Components of process flow 400 that are identified by black boxes relate to back-end processing components, which are not viewable by a client computing device. For instance, back-end processing components may produce a result (e.g. filtered message content) that is provided to a client computing device. While process flow 400 illustrates one example of service operation for providing a visibility service, one skilled in the art that understands the present disclosure should recognize that components of process flow 400 are not limited to being strictly front-end or back-end processing components.

Process flow 400 comprises an exemplary media call application/service 402, for example, as described in the foregoing. In one example, the media call application/service 402 is executing on a client computing device. However, in alternative examples, a client computing device may access the media call application/service 402 over network connection. The media call application/service 402 interfaces with a communication session management component 404 and components associated with an exemplary visibility service.

The communication session management component 404 is configured to manage an exemplary communication session provided by the media call application/service 402. A media call application may enable users to connect to each other through a communication session. A communication session is an instance within the media call application where a connection is established with one or more participants. A participant is a user of an exemplary media call application/service. A participant is associated with a user account. In one example, the user account is specific to the media call application/service. In another example, the user account is a universal log-in for a plurality of applications/services, for example, provided by a platform.

A connection may be established for a communication session by one or more of PSTN and/or IP telephony with the computing device and one or more other computing devices or telephonic devices. Furthermore, an exemplary media call application may be configured to enable users to connect via voice calls or VoIP calls, where an exemplary communication session may extend capabilities of the media call application/service by providing functionality including but not limited to: video capabilities (e.g. through a web camera), text/SMS messaging capabilities, handwritten input processing, recording capabilities, an ability to access exemplary message content, an ability to share documents and/or displays, an ability to create conference calls, and ability to manage communication sessions and/or contact information, among other examples. Other components and/or services provided by media call applications are known to one skilled in the field of art. In examples, an exemplary media call application may interface with a component of a distributed network to receive configuration information for an exemplary communication session.

During an executing communication session, the communication session management component 404 may be configured to interface with a content search ingestion service component 406. The communication session management component 404 may provide signal data to the content search ingestion service component 406. Signal data that pertains to any information associated with the communication session. Signal data may comprise but is not limited to: information relating to participants joining/leaving the communication session, information on content being accessed, methods of communication (e.g. audio/video, messaging), content being accessed, query requests for message content and history data including signal data from previous communication sessions and/or conversations, among other examples. As an example, active signal data from an active communication session may be provided to the content search ingestion service component 406 in real-time. Historical signal data pertaining to previous communication sessions/conversations may be collected by the content search ingestion service component 406 at other times, for example, in an offline operation. In one example, signal data (e.g. active and historical) may be associated with participants of a communication session.

The content search ingestion service component 406 is configured to receive signal data from the communication session management component 404. An exemplary visibility service 410 interfaces with the content search ingestion service component 406. The content search ingestion service component 406 may provide the visibility service 410 with signal data from active and/or historical communication sessions.

The visibility service 410, referenced in the foregoing, may be utilized to signal data to filter message content for viewing in a communication session. While examples referenced in process flow 400 relate to providing message content within a communication session, alternate examples may relate to providing access to message content through the media call application/service 402 even when a participant is not in an active communication session.

While in a communication session, a participant may initiate a query for access to message content. In alternate examples, the visibility service 410 may interface with a media call application/service 402 to provide filtered content even when a query is not received. When a query is initiated by a participant of a communication session, the query is processed by the content search query component 408. The content search query component 408 executes processing operations to parse and evaluate the query (e.g. language understanding processing and/or predictive analysis) and reformat the query for recognition purposes. In doing so, the content search query component 408 may interface with other application services to assist with query processing. Examples of platform resources and application services have been described in the foregoing.

The visibility service 410 receives the query (from the content search query component 408) as well as signal data (from the content search ingestion service component 406). The visibility service 410 applies exemplary visibility rules that are utilized to evaluate whether a user of a media call application (e.g. participant in a communication session) is authorized to view the message content. Further examples of components of the visibility service 410 and exemplary visibility rules are provided in the subsequent description of process flow 420 (FIG. 4B).

Message content is managed by the conversation collection component 412. The visibility service 410 may interface with the conversation collection component 412 to access the message content and apply visibility rules to filter the message content for return to the media call application service 402. In doing so, the visibility service 410 may utilize the received signal data to identify message content for the participants of the communication session or other operating instance of an exemplary media call application/service. In examples where a query is received requesting a searching of message content, the visibility service 410 may further use the query for filtering processing operations. Once the visibility service 410 has identified message content, the visibility service 410 may apply exemplary visibility rules to filter the message content, for example, based on query input. In at least one example, a query may comprise a selection of a user interface feature (e.g. provided through the media call application) that enables a user to organize and/or filter message content. For instance, a user may select to filter message content by time/date, communication session, as pertaining to specific users (or participants of a communication session/executing instance of a media call application), etc. Filtered message content may be transmitted to the media call application/service 402, for example, via the content search query service component 408.

FIG. 4B is a process flow 420 diagramming components of an exemplary visibility service with which aspects of the present disclosure may be practiced. An exemplary visibility service 410 is described in the foregoing description of process flow 400 (FIG. 4A). For ease of understanding, components of process flow 420 that are identified by black boxes relate to back-end processing components, which are not viewable by a client computing device. For instance, back-end processing components may produce a result (e.g. filtered message content) that is provided to a client computing device. While process flow 420 illustrates one example of service operation for providing a visibility service, one skilled in the art that understands the present disclosure should recognize that components of process flow 420 are not limited to being strictly back-end processing components.

As shown in process flow 420, the visibility service 410 may comprise a plurality of components that are utilized to enable filtering of exemplary message content. The visibility service 410 may comprise: a user/group association management component 422, a visibility rules management component 424 and conversation collection component 412 (as described in process flow 400 for FIG. 4A). The conversation collection component 412 is configured to enable the visibility service 410 to one or more data stores of message content, for example, to filter the message content based on application of exemplary visibility rules. In application, the visibility service 410 may provide a visibility index that is utilized to evaluate user access to content. An exemplary visibility index may be generated based on data collected using one or more components of the visibility service 410.

The user/group association management component 422 is configured to manage user data, for example, data that relates to users of a media call application/service and/or users of a platform that provides access to a plurality of applications/services. User data may comprise but is not limited to: data corresponding with a user account including profile information and account settings, saved preferences, data access history, privileges set for access to content affiliated with the user and social media content, among other examples. User data may further comprise associations of the user that include associations with other users, specific groups, teams, affiliations, etc. In one example, a user (having a group association) may be a participant in an exemplary communication session with other group members. In such an example, an exemplary visibility service 410 can filter message content that is specific to the group association. The user/group association management component 422 interfaces with the visibility rules management component 424 to provide data (e.g. signal data) identifying specific associations of a user.

The visibility rules management component 424 manages exemplary visibility rules that are applied to identify (and filter) message content that a user is authorized to access. Visibility rules may pertain to but are not limited to the following examples: user-specific association rules, group-specific association rules, content-specific rules, application-specific rules (e.g. media call application) and communication session setting rules, among other examples. One skilled in the art that understands the present disclosure should recognize that visibility rules can be evaluate other types of data and/or associations, where developers can vary the different sets of visibility rules applied to manage strictness of an authorization level for filtering message content. In some examples, the visibility service applies different sets of visibility rules are applied in aggregate to determine whether a user is authorized to access message content and/or which content to provide in a communication session.

Exemplary visibility rules may comprise rules that can be applied to evaluate group associations of a user such as a participant in a communication session. For instance, privileges set at a group level are evaluated to determine whether a user is authorized to access/view message content such as message content that is specific to a group of users. In some instances, users that are not part of a group may still be granted access to content, for example, where privileges associated with a group enable sharing of content. Specific privileges may be set for message content associated with a group.

Furthermore, exemplary visibility rules may comprise rules that can be applied to evaluate associations of a user, for example, associations pertaining to a user account of the user. As an example, a user may have settings or preferences enables for access to content that is affiliated (e.g. managed, owned, stored) with a user account. In one example, a user account may have sharing privileges associated with the user account. The visibility service 410 is configured to apply rules to evaluate and enforce associations of a user when filtering message content.

In further examples, exemplary visibility rules may comprise rules that evaluate content-specific associations related to message content. For instance, access rules may be set to evaluate whether privileges exist for access to specific instances of message content. For example, a document owner may set sharing privileges for message content that can be evaluated and enforced through rules applied by the visibility service 410.

Moreover, exemplary visibility rules may comprise rules for evaluating setting associations for the communication session. For instance, access rules may be set to evaluate sharing privileges within the communication session. As an example, a user of a media call application/service may provide preferences/settings that can be applied to communication sessions. In some instances, preferences/settings may pertain to sharing and access to message content, for example, during an exemplary communication session.

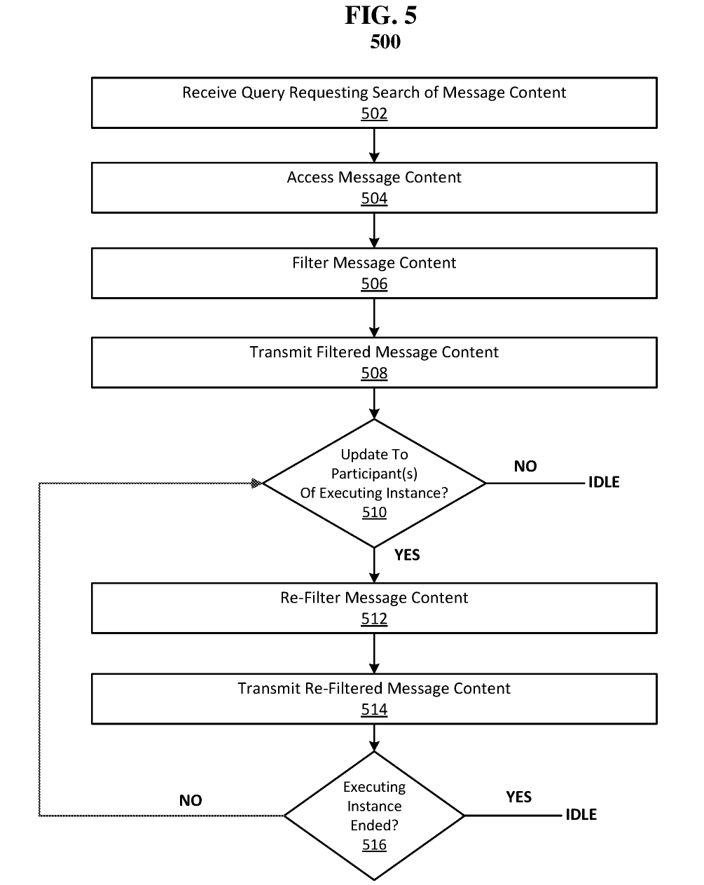

FIG. 5 is an exemplary method 500 related to processing of an exemplary visibility service with which aspects of the present disclosure may be practiced. As an example, method 500 may be executed by an exemplary processing device and/or system such as those shown in FIGS. 1-3. In examples, method 500 may execute on a device comprising at least one processor configured to store and execute operations, programs or instructions. Operations performed in method 500 may correspond to operations executed by a system and/or service that execute computer programs, application programming interfaces (APIs), neural networks or machine-learning processing, among other examples. As an example, processing operations executed in method 500 may be performed by one or more hardware components. In another example, processing operations executed in method 500 may be performed by one or more software components. In some examples, processing operations described in method 500 may be executed by one or more applications/services associated with a web service that has access to a plurality of application/services, devices, knowledge resources, etc. Processing operations described in method 500 may be implemented by one or more components connected over a distributed network.

Method 500 begins at processing operation 502, where a query is received through an exemplary media call application/service. In one example, the query may be associated with a communication session. However, a query may be received through any executing instance of a media call application/service including but not limited to: messages, emails, communication sessions and individual operating instances where a user signs into the media call/application service, among other examples. An exemplary query may pertain to a request for access to message content, as described in at least the description of process flow 400 (FIG. 4A). Message content may be accessed and evaluated by an exemplary visibility service that may be associated with an exemplary media call application/service. As described previously, a visibility service may be configured to interface with any type of application/service to provide access to and filtering of message content.

A query may be received (processing operation 502) from a client computing device, for example, that is executing an exemplary media call application. In one example, the query may be received (processing operation 502) at an exemplary content search query service 408 as described in at least the description of process flow 400 (FIG. 4A), which transmits the query to an exemplary visibility service for filtering of message content. In an alternative example, the query may be directly received (processing operation 502) at an exemplary visibility service. In any example, one or more computing devices associated with an exemplary visibility service receive (processing operation 502) the query for processing. An exemplary query may pertain to a search request of message content associated with one or more users of a media call application. In at least one example, a search query may be associated with user interface feature selection within a media call application.

Flow may proceed to processing operation 504, where exemplary message content is accessed. The visibility service is configured to provide access to one or more data stores that may be associated with user of a media call application/service (e.g. a participant in an exemplary communication session). Portions of message content may be identified based on a context of a received query, where access to (and display of) message content may be updated based on a received query. As an example, a visibility service may manage access to message content using a conversation collection component 412 described in at least the descriptions of FIGS. 4A and 4B. In accessing (processing operation 504) message content, the visibility service may utilize signal data (e.g. active signal data and/or historical signal data) associated with one or more users of a media call application/service. As an example, signal data may pertain to participant involvement in active or past communication sessions of the media call application/service.

The visibility service is configured to filter (processing operation 506) the message content. Processing operation 506 based on an application of visibility rules that are utilized to evaluate whether a user of the media call application is authorized to access the message content. In one example, the visibility rules may evaluate whether a participant, of the one or more participants, in a communication session is authorized to access the message content. Description pertaining to exemplary visibility rules and application of exemplary visibility rules to filter message content is provided in at least the foregoing description of process flow 420 (FIG. 4B). As an example, visibility rules may be set to evaluate one or more sets of associations of a user (e.g. associations of a user account of the user, group associations, application/service setting associations, content-specific associations, etc.).

Once message content is filtered based on application of exemplary visibility rules, flow may proceed to processing operation 508, where the filtered message content is transmitted for display in an exemplary media call application/service. For instance, processing operation 508 may comprise transmitting the filtered message content to a client computing device that is executing a media call application. The filtered content may be provided to a user directly within the media call application. As an example, the filtered message content may be displayed in an executing instance (e.g. home screen of application after sign-in, active communication session, etc.) of the media call application/service.

In examples where a user is involved in a communication session, participation may change within an active communication session. Flow may proceed to decision operation 510, where participation in a communication of the media call application/service is evaluated. For example, filtering of message content may be modified based on a change to participation within a communication session. In one instance, a participant may join/leave a communication session, where an exemplary visibility service may receive updated signal data pertaining to a change in participants of a communication session. If no change to participation occurs, flow branches NO and processing of method 500 remains idle, for example, until a subsequent query is received or a communication session is ended. In alternate examples where a user is not involved in an active communication session, signal data pertaining to the user (and past communication sessions) may be used to make a re-filtering determination. In one example, a re-filtering may occur based on a new query (or update to a received query).

If a user is involved in an executing instance of an application and an update to participation in the executing instance is detected, flow branches YES, and the visibility service may re-filter (processing operation 512) message content. The process of re-filtering may comprise similar processing operations to those described for the original filtering (processing operation 506) of message content. The re-filtered message content may be transmitted (processing operation 514) to a media call application/service, for example, that is executing on a client computing device.

Flow may proceed to decision operation 516, where it is determined whether an executing instance of an application has ended. As an example, an executing instance is a communication session of an exemplary media call application/service. A communication session may be ended based on one or more of the following: all participants have exited a communication session, a lead participant of a communication session has terminated the communication session and the communication session remains idle for a predetermined amount of time. However, it should be recognized that management of communication sessions may vary based on setting associated with an exemplary media call application/service. If it is determined that an executing instance of a media call application/service has ended, flow branches YES and processing remains idle until subsequent processing is received through the media call application/service. In some instances, message content is still accessible to a participant even outside of an executing instance such as a communication session. An exemplary visibility service may re-filter content in such instances. If it is determined that an executing instance has not ended, flow branches YES and processing of method 500 returns to decision operation 510.

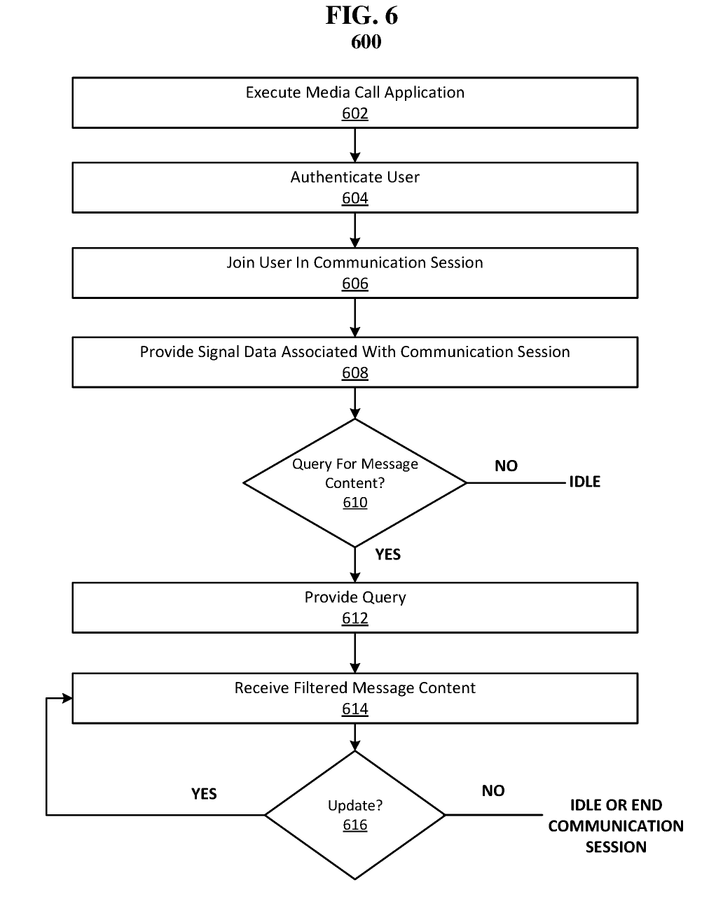

FIG. 6 is an exemplary method 600 related to client side processing for execution of an exemplary media call application with which aspects of the present disclosure may be practiced. As an example, method 600 may be executed by an exemplary processing device and/or system such as those shown in FIGS. 1-3. In examples, method 600 may execute on a device comprising at least one processor configured to store and execute operations, programs or instructions. Operations performed in method 600 may correspond to operations executed by a system and/or service that execute computer programs, application programming interfaces (APIs), neural networks or machine-learning processing, among other examples. As an example, processing operations executed in method 600 may be performed by one or more hardware components. In another example, processing operations executed in method 600 may be performed by one or more software components. In some examples, processing operations described in method 600 may be executed by one or more applications/services associated with a web service that has access to a plurality of application/services, devices, knowledge resources, etc. Processing operations described in method 600 may be implemented by one or more components connected over a distributed network.

Method 600 begins at processing operation 602, where an exemplary media call application is executed. Examples pertaining to an exemplary media call application/service have been provided in the foregoing. As an example, a client computing device may be executing (processing operation 602) the media call application/service.

Flow may proceed to processing operation 604, where a user is authenticated for access for utilization of a media call application/service. As an example, a user may login to the media call application, providing a first layer of protection where a user is authenticated for use of the media call application as well as access to message content that may be provided through the media call application. As previously described, a user may login through a user account, which may be specific to a media call application and/or a universal login for access to application/services of a platform.

Flow may proceed to decision operation 606, where a user joins a communication session. In examples, a user may access a communication session through the media call application/service. Once the user joins the communication session, the user becomes an active participant in the communication session. When a user joins a communication session, signal data associated with the communication session is transmitted for subsequent processing. That is, a client computing device that is executing a media call application may provide (processing operation 608) signal data for subsequent processing. Examples of transmission of signal data and processing of the signal data have been described in the foregoing. In one example, a communication session management component 404 (as described in the description of FIG. 4A) may manage a communication session and provide signal data to an exemplary visibility service.

Flow may proceed to decision operation 610, where it is determined whether a query for message content is provided. In one example, a query may be received through (and processed at) a client computing device, which may transmit/provide (processing operation 612) the query for subsequent processing. If no query is received, flow branches NO and processing of method 600 remains idle, for example, until message content is to be filtered. If a query is received, flow branches YES and proceeds to processing operation 612, where the query is provided for subsequent processing. In one example, a query is received from an active communication session in a media call application. As described in alternative examples, a query may be received the media call application from outside of a communication session. In some examples, filtered content may be provided to the media call application and imported into an active communication session, for example, by a user (e.g. participant in an active communication session).

Processing operations related to subsequent query processing including using the query to filter/re-filter message content have been described in the foregoing. As an example, a visibility service may utilize the query to filter message content. Filtered message content may be received (processing operation 614) at the client computing device, for example, that is executing the communication session via the media call application.

Flow may proceed to decision operation 616, where is it determined whether an update is received to the visibility of the message content. Examples that may trigger update to message content have been provided in the foregoing. If an update to message content is received, flow branches YES and processing returns to processing operation 614, where filtered message content is received. If no update to the message content is received, flow branches NO and processing remains idle in examples where the communication session remains active. In alternative examples, detection that a communication session has ended finishes processing of method 600.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving a query requesting access to content, wherein the query is provided through a media call application;
accessing message content through a service associated with the media call application based on the received query;
filtering the message content based on an application of visibility rules that are utilized to evaluate whether a user of the media call application is authorized to access the message content, wherein the visibility rules comprise rules that evaluate:
one or more associations of the user, and
access rules pertaining to the one or more associations of the user; and
transmitting, to the media call application, the filtered message content for display within the media call application.

2. The method of claim 1, wherein the one or more associations comprise a group association of the participant, and wherein the access rules comprise privileges set for the group association including content specific privileges for message content that corresponds with the group association.

3. The method of claim 1, wherein the query is received from a communication session executing in a media call application, wherein the accessed message content is associated with one or more participants of the communication session, and wherein the filtering filters the message content to evaluate whether a participant of the communication session is authorized to access the message content.

4. The method of claim 3, wherein the visibility rules further comprise: rules that evaluate setting associations for the communication session and access rules pertaining to the setting associations that evaluate sharing privileges within the communication session.

5. The method of claim 3, further comprising: receiving a signal that the participant has exited the communication session; updating the visibility rules based on the received signal; re-filtering the message content based on application of the updated visibility rules; and transmitting, to the media call application, the re-filtered content.

6. The method of claim 1, wherein the visibility rules further comprise: rules that evaluate user associations corresponding with a user account that is affiliated with the message content and access rules pertaining to the user associations that evaluate sharing privileges associated with the user account.

7. The method of claim 1, wherein the visibility rules further comprise: rules that evaluate content-specific associations of the message content and access rules pertaining to the content-specific associations that evaluate access privileges for the message content.

8. A system comprising:
at least one processor; and
a memory operatively connected with the at least one processor storing computer-executable instructions that, when executed by the at least one processor, causes the at least one processor to execute a method that comprises:
receiving a query requesting access to content, wherein the query is provided though a media call application,
accessing, based on the received query, message content through a service associated with the media call application,
filtering the message content based on an application of visibility rules that are utilized to evaluate whether a user of the media call application is authorized to access the message content, wherein the visibility rules comprise rules that evaluate:
one or more associations of the user, and
access rules pertaining to the one or more associations of the user, and
transmitting, to the media call application, the filtered message content for display within the media call application.

9. The system of claim 8, wherein the one or more associations comprise a group association of the user, and wherein the access rules comprise privileges set for the group association including content specific privileges for message content that corresponds with the group association.

10. The system of claim 8, wherein the message content is associated with past communication sessions from the media call application, and wherein the past communication sessions are associated with one or more participants of an active communication session of the media call application.

11. The system of claim 8, wherein the visibility rules further comprise: rules that evaluate user associations corresponding with a user account that is affiliated with the message content and access rules pertaining to the user associations that evaluate sharing privileges associated with the user account.

12. The system of claim 8, wherein the visibility rules further comprise: rules that evaluate setting associations for a communication session of the media call application and access rules pertaining to the setting associations that evaluate sharing privileges within the communication session.

13. The system of claim 8, wherein the visibility rules further comprise: rules that evaluate content-specific associations of the message content and access rules pertaining to the content-specific associations that evaluate access privileges for the message content.

14. The system of claim 8, wherein the executed method further comprises: receiving a signal that the participant has exited an active communication session of the media call application, updating the visibility rules based on the received signal, re-filtering the message content based on application of the updated visibility rules, and transmitting, to the media call application, the re-filtered content.

15. A computer-readable medium storing computer-executable instructions that, when executed by at least one processor, causes the at least one processor to execute a method comprising:
receiving a query requesting access to content, wherein the query is provided though a media call application;
accessing, based on the received query, message content associated with one or more participants of a communication session occurring through the media call application;
filtering the message content based on an application of visibility rules that are utilized to evaluate whether a participant of the communication session is authorized to access the message content, wherein the visibility rules comprise rules that evaluate:
one or more associations of the participant, and
access rules pertaining to the one or more associations of the participant; and
transmitting, to the media call application, the filtered message content for display within the communication session.

16. The computer-readable medium of claim 15, wherein the one or more associations comprise a group association of the participant, and wherein the access rules comprise privileges set for the group association including content specific privileges for message content that corresponds with the group association.

17. The computer-readable medium of claim 15, wherein the visibility rules further comprise:
rules that evaluate user associations corresponding with a user account that is affiliated with the message content and access rules pertaining to the user associations that evaluate sharing privileges associated with the user account.

18. The computer-readable medium of claim 15, wherein the visibility rules further comprise:
rules that evaluate setting associations for the communication session and access rules pertaining to the setting associations that evaluate sharing privileges within the communication session.

19. The computer-readable medium of claim 15, wherein the visibility rules further comprise:
rules that evaluate content-specific associations of the message content and access rules pertaining to the content-specific associations that evaluate access privileges for the message content.

20. The computer-readable medium of claim 15, wherein the method further comprising: receiving a signal that the participant has exited the communication session; updating the visibility rules based on the received signal; re-filtering the message content based on application of the updated visibility rules; and transmitting, to the media call application, the re-filtered content.
